(19) United States
(12) Patent Application Publication
(10) Pub. No.: US 2010/0230254 A1
(43) Pub. Date: Sep. 16, 2010

(54) Ultrasonic Ice Breaker Replacement for Ice Resurfacing Machines

(76) Inventor: Patrick R. Manion, Paradise Valley, AZ (US)

Correspondence Address: Hartman Law PLC, 7114 E. Stetson Drive, Suite 205, scottsdale, AZ, 85251, US

(21) Appl. No.: 12/279,714

(22) PCT Filed: Jul. 25, 2008
(86) PCT No.: PCT/US08/71273

§ 371 Date: Aug. 16, 2008

Related U.S. Application Data
(60) Provisional application No. 60/951,934, filed on Jul. 25, 2007.

(51) Int. Cl. B65G 45/10; B06B 1/06; E01H 4/00; E01H 4/02

(52) U.S. Cl. 198/860.3; 310/334

(57) ABSTRACT

An ice re-surfacing machine an acoustically isolated face shield around the intake mouth of its vertical conveyor housing. Ultrasonic vibrations induced in the shield prevent build-up of ice from cuttings thrown at the mouth by the machine's horizontal conveyor.

### CROSS REFERENCE TO RELATED APPLICATIONS

This Application claims the benefit of priority of U.S. Provisional Application Ser. No. 60/951,934, filed Jul. 25, 2007.

### BACKGROUND OF THE INVENTION

An ice re-surfacing machine for skating rinks and the like has two basic parts. The first is the main wheeled body driven over the ice, usually on standard rubber tires. The body generally includes motive power, an operator's seat and controls, a collection system and storage bin for ice cuttings, water tanks for the ice-washing and ice-making process, and a hydraulic arms system for carrying and positioning the ice re-surfacing apparatus.

The second part is the apparatus that re-surfaces the ice in a single pass. This structure, which is towed over the ice by the main body, is generally referred to as the “conditioner,” but sometimes is called the “sled”. The conditioner, carried at the back of the main body on hydraulically activated arms, is essentially an open-bottomed steel box that allows the re-surfacing components access to the ice surface when lowered into operating position and pulled across the ice. A runner and side plate on each side, parallel to the direction of travel, supports the conditioner in operation and confines the ice chips and water used in re-surfacing.

The majority of imperfections created in the ice surface by ice-skating are limited to one to two millimeters of ice depth. The conditioner holds a large blade, usually steel, that shaves a very thin layer off the ice surface. Generally, the blade is attached to a supporting draw bar, which is mounted to the conditioner frame.

Ice cuttings generated by the shaving blade must be removed from the surface as the blade is pulled along. Mounted forward of and parallel to the blade is a screw conveyor, variously known as a “horizontal conveyor” or “horizontal auger” or “horizontal screw.” The horizontal conveyor comprises a cylindrical shaft onto which a helical flange, referred to as a “flight,” is wound around and attached, similarly to the thread on a wood screw. The helical flight converts the rotational spin of the shaft into linear motion parallel to the shaft.

In most ice-resurfacing machines, the horizontal conveyor is configured so that flights on the left side move ice shavings from the outside toward the center of the conveyor, and flights on the right side move ice shavings from the outside toward the center as well. In the center of the horizontal conveyor, flat plates mounted parallel to the rotational axis of the shaft, called “paddles”, connect to the left side and right side auger flights. The paddles are part of the “slinger”, which transfers ice shavings to a vertical conveyor. In operation, the blade shaves the ice, creating particles that build up in front of the blade and are caught in the flights of the horizontal conveyor. The horizontal conveyor's rotating flights move the ice particles to the center, where the slinger throws them onto the vertical conveyor.

The vertical conveyor is designed to accept the stream of ice cuttings thrown from the slinger of the horizontal conveyor and move them upward for placing into the ice cuttings storage tank in the main body. The vertical conveyor is also a screw type conveyor, similar in design and function to the horizontal conveyor. All of the helical flights are wound around the central shaft in the same direction, imparting a continuous upward movement of ice cuttings from the bottom of the conveyor to the top. At the top, slinger paddles sweep the cuttings into the storage tank. The vertical conveyor is encased in a close fitting metal tube running the length of the auger. A lower aperture, facing the slinger of the horizontal conveyor, receives ice cuttings from the slinger, whereby the cuttings begin ascending on the flights. An aperture at the top faces the ice cuttings storage tank. The vertical conveyor slinger paddles throw the ice cuttings into the tank.

Behind the blade and draw bar is a wash water system that discharges cold water through a manifold that sits parallel to the blade. The wash water system includes a rubber squeegee mounted on the bottom of the back wall of the conditioner and a suction pump with an intake that projects nearly to the surface along that back wall. In operation, cold water from a tank in the main body is discharged onto the ice surface just behind the blade assembly, and is constrained by the side runners and the squeegee as the machine moves forward. By regulating the flow of water and the suction of the collection pump, the operator maintains a wash water pool of constant size behind the blade assembly. This moving pool floats contaminants off the ice surface and floods any deep grooves and pits in the ice surface, then is collected and returned to the water tank.

The last part of the conditioner is the ice maker, mounted to the back wall of the conditioner. A discharge manifold sprays multiple small jets of hot water from a tank in the main body onto the outside back wall of the conditioner, where it forms a continuous sheet of water cascading down onto the ice across the conditioner's entire width. Finally a cloth water spreader, called a “mop”, evenly spreads and polishes the ice making water into a smooth surface.

Conventional ice re-surfacing machines suffer from build-up of ice particles around the mouth or intake aperture of the vertical conveyor. Because of conditions during operation, ice cuttings from the blade, thrown by the horizontal slinger, stick to the surface around the mouth and build up so as to block part or substantially all of the aperture. Conventional ice resurfacing machines use a wiper or mechanical ice breaker to break up and clear off the ice after it builds up, requiring attention and effort from the operator, as well as frequent maintenance of the mechanism. The present invention employs ultrasonic vibration to inhibit, break up and dissipate any ice build-up at the mouth.

### SUMMARY OF THE INVENTION

The ice resurfacing machine of the present invention applies ultrasonic frequency vibration to a shield surrounding the intake aperture of the vertical conveyor. In one embodiment, piezoelectric transducers, driven by an ultrasonic frequency generator, are mounted to the shield. The vibrating shield kinetically repels some of the ice cuttings thrown against the surface, and the vibration energy transfers to the ice crystals that do stick, either heating and melting the liquid interface between the ice and the shield or shaking the particles and liquid off the surface.

### DRAWINGS

FIG. 1 is a schematic of an ice resurfacing machine.

FIG. 2 shows a side view of a vertical conveyor and shield in respect to the conditioner.

FIG. 3 is a front view of one embodiment of the invention.

FIG. 4 is a top view of the shield of FIG. 3.

FIG. 5 is an end view of the shield of FIG. 3.

FIG. 6 is a side view of a vertical conveyor showing the auger flights and a mounted shield.

FIG. 7 is a top view of the vertical conveyor and shield of FIG. 6.

FIG. 8 is a front view of the vertical conveyor and shield of FIG. 6.

FIG. 9 is a schematic of a transducer element used in an embodiment of the invention.

FIG. 10 is a schematic of the transducer of FIG. 9 in a protective cover.

FIG. 11 is a schematic of a transducer mounted to the back of a shield according to the present invention.

FIG. 12 is a schematic of the present invention showing connection to a wave generator and power supply.

FIG. 13 is a top view of an embodiment of the present invention attached to a vertical conveyor.

FIG. 14 is a close view of the mounting assembly connecting a shield with a vertical conveyor tube.

### DETAILED DESCRIPTION

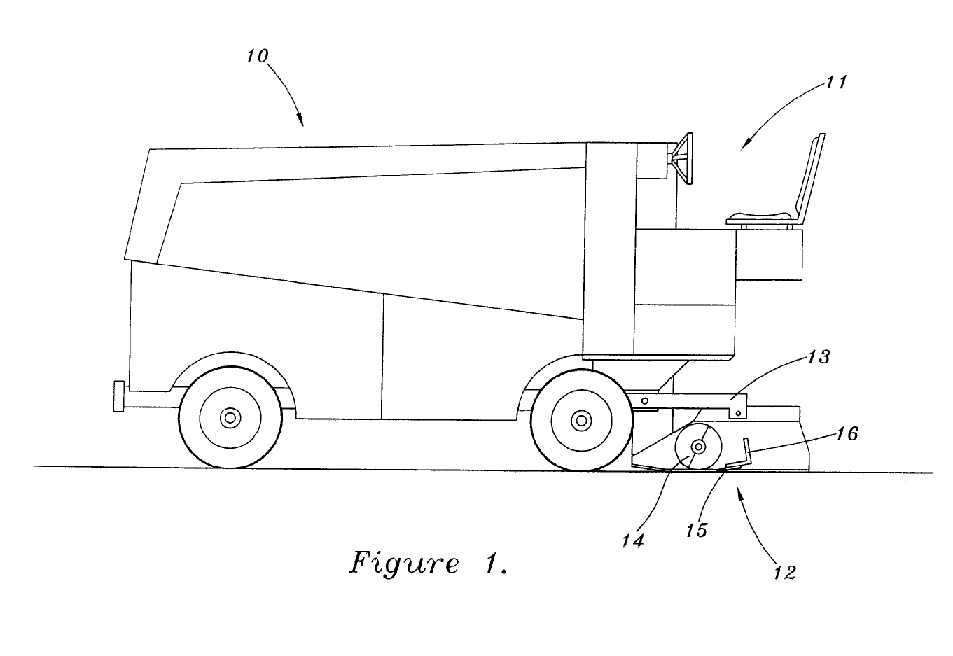

A schematic of a standard ice resurfacing machine is shown in FIG. 1. Main body (10) encloses an internal combustion motor or electric motor for propelling the unit and powering other components. It also encloses a storage tank for ice shavings, tanks for wash water and ice making water, and an operator's seat and controls (11). The sled or conditioner (12) is attached to main body (10) by hydraulic arms (13).

FIG. 1 shows only some of the components of conditioner (12). A horizontal conveyor (14) for moving ice shavings to the center and throwing them onto a vertical conveyor (9) is placed forward of shaving blade (15) mounted to draw bar (16). Remaining elements of the conditioner are not shown.

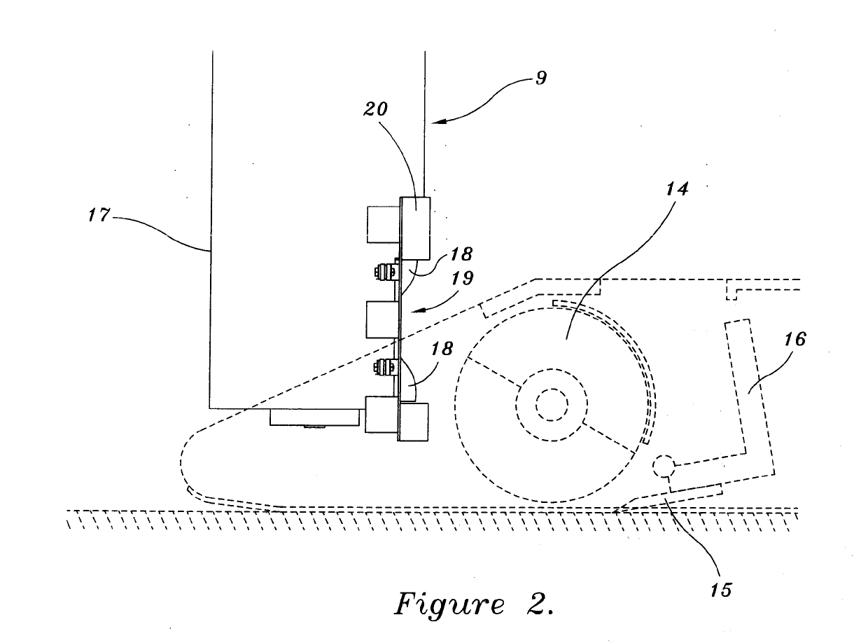

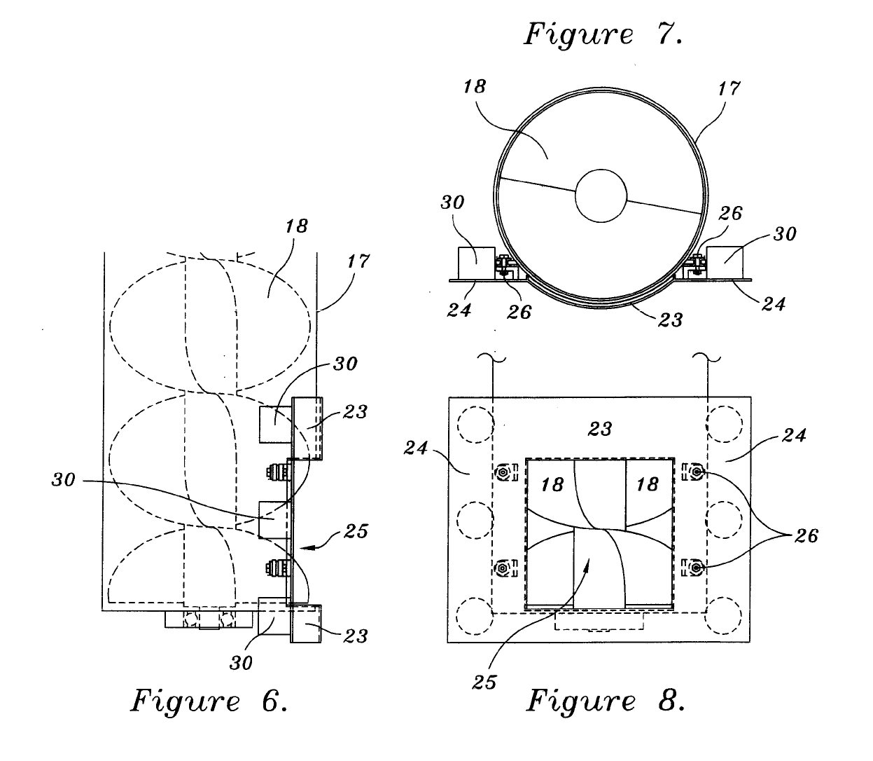

FIGS. 2 and 6 show the vertical conveyor with an embodiment of the present invention attached. A steel enclosing tube (17) surrounds a shaft with helical flights (18) that carry ice particles upward to the storage tank. In operation as the machine moves forward, blade (15) attached to draw bar (16) shaves the ice and a mound of ice cuttings is pushed in front of the blade. Horizontal conveyor (14) engages the ice cuttings and moves them to its center, where a slinger throws them into the vertical conveyor through the intake aperture or mouth (19), where the flights (18) of the vertical conveyor carry the cuttings upward. The mouth is where ice builds up, eventually blocking the opening, and has to be removed periodically.

An embodiment of the shield itself is shown in FIGS. 3-5, and FIGS. 6-8 show the shield in place on vertical conveyor (9). The shield is configured to fit closely around mouth (19). Shield (20) has a curved portion (23) that follows the curvature of the vertical conveyor tube (17) and an aperture (25) in the curved portion that corresponds to the configuration of the mouth (19) of the vertical conveyor. Left and right side wing portions (24) extend in a plane roughly parallel to the axis of horizontal conveyor (14) and are dimensioned to hold ultrasonic transducers (30). Mounting assemblies (26) secure the shield to the enclosing tube (17) in a manner that isolates the transmission of ultrasonic vibrations to the tube.

Shield (20) is preferably constructed out of a material that is a good conductor of ultrasonic vibrations, such as steel or aluminum. The transducers (30) are mounted directly to the shield to provide a good sonic connection. As noted below, it is desirable to isolate the shield sonically from the vertical conveyor enclosing tube to avoid dissipation of ultrasonic vibration energy from the shield.

The present invention suppresses and dissipates ice build-up from cuttings thrown at the mouth by inducing high-frequency vibrations in the shield during operations. The vibration frequency is preferably in the ultrasonic range of 20,000 to 100,000 Hertz, which provides high motion cycling with less energy dissipation into heat that is characteristic of higher frequency vibrations. Various known types of transducers may be employed to impart the high frequency vibrations. In one embodiment, solid state piezoelectric transducers are attached for this purpose. Piezoelectric transducers are available in a variety of shapes, sizes and operational characteristics.

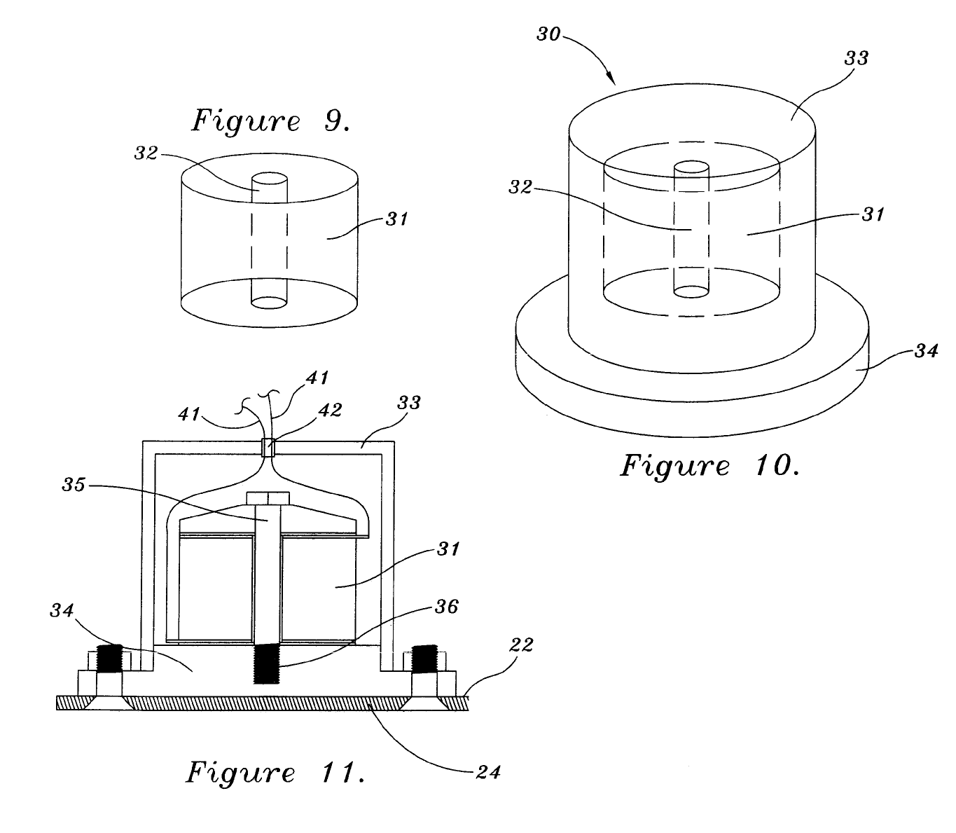

FIG. 9 illustrates a transducer used in one embodiment. Element (31) is a cylinder of piezoelectric material having a center bore (32) for attaching to the unit. Because the environment where the transducer is used includes stray ice shavings, water, and cold, it is helpful to encase the piezoelectric element in a protective cover. FIG. 10 illustrates one embodiment of the transducer unit. Cover (33) is a protective hollow cylinder, open at one end, that fits over cylindrical element (31). Transducer element (31) is attached to base (34) in a way that efficiently transfers vibrations to the base.

FIG. 11 is a more detailed view of the mounted transducer unit. Piezoelectric element (31) is enclosed in cover (33). Mounting bolt (35) through center bore (32) fits into a threaded receptacle (36) in base (34). The transducer is firmly attached to the base for sonic vibration conductivity. Transducer assembly (30) is firmly attached for sonic vibration transmittal to the shield assembly (20). In one embodiment, the transducer is mounted on the rear face (22) of the wing portion (24) of the shield. Conducting wires (41) are attached to contact points on the transducer. Conducting wires (41) pass through a hermetic seal in an aperture (42) in the cover. Wires (41) connect to a signal generator for the transducer.

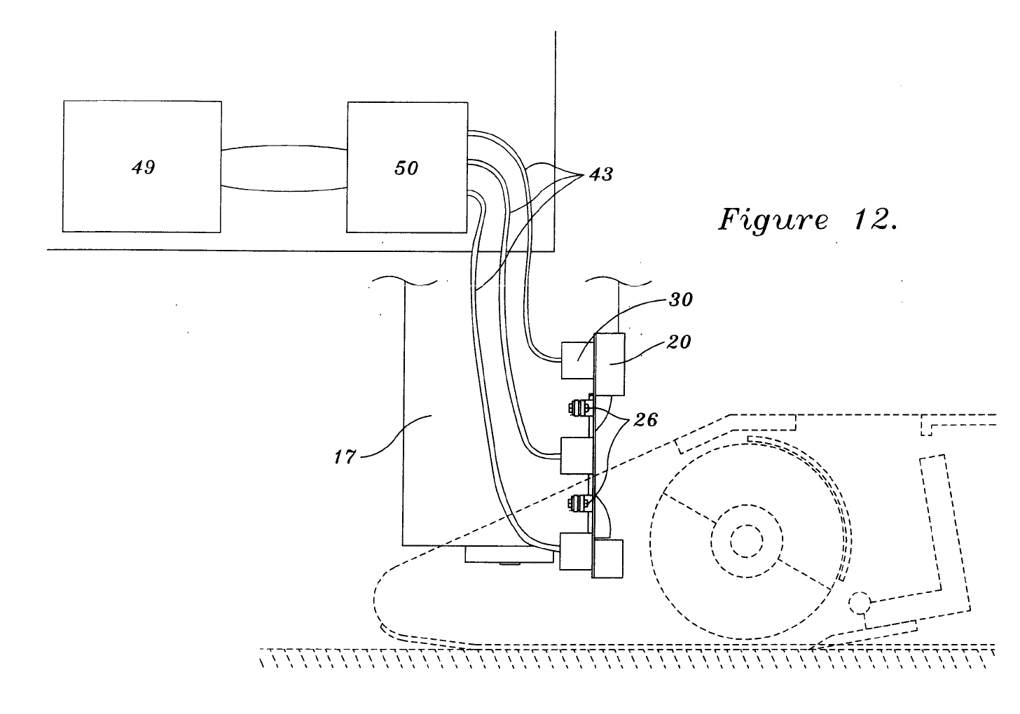

Vibration of the transducer is instigated and controlled by a standard ultrasonic frequency generator (50), which preferably is variably controlled, inside the main body housing. The frequency generator is connected to a power source (49) which may be a battery or a generator associated with the drive engine as shown schematically in FIG. 12. Control functions may be located within reach of the operator. A safety mechanism that turns off the vibrator when the machine is not throwing ice at the mouth is desirable.

Preferably, the system will produce ultrasonic vibration of the shield assembly in the most energy efficient way possible. The ideal frequency for use with a specific shield assembly will depend on its specific shape and weight, which depends o the size and shape of the vertical conveyor to which it is matched and thus is model specific. So the ideal vibrational frequency for a specific model of machine will be determined experimentally.

Vibration may be imparted in the shield by a single transducer or by a plurality of transducers. Optimal performance is achieved when the entire shield is vibrating with sufficient energy to dissipate ice build-up, there are no dead spots that fail to vibrate and there are few or no locations where unnecessary excess energy is infused. FIGS. 3 and 8 shows a shield with a spacing of six transducers on the back side of the wing portion of the shield. Depending on the model specific size and shape of the shield, other quantities and spacing of transducers including use of a single transducer may be utilized.

The shield is attached to the vertical conveyor housing, and the attachment points will always offer a path for some loss of ultrasonic vibrational energy onto the housing. Acoustical isolation is desirable to minimize any such loss. In one embodiment, the shield is mounted to the vertical conveyor housing by four small mounting pins with small cross sections. Preferably the mounting pins will provide acoustical isolation between the shield and the conveyor by grommets made of material, such as rubber or plastic, that does not conduct the sound vibrations.

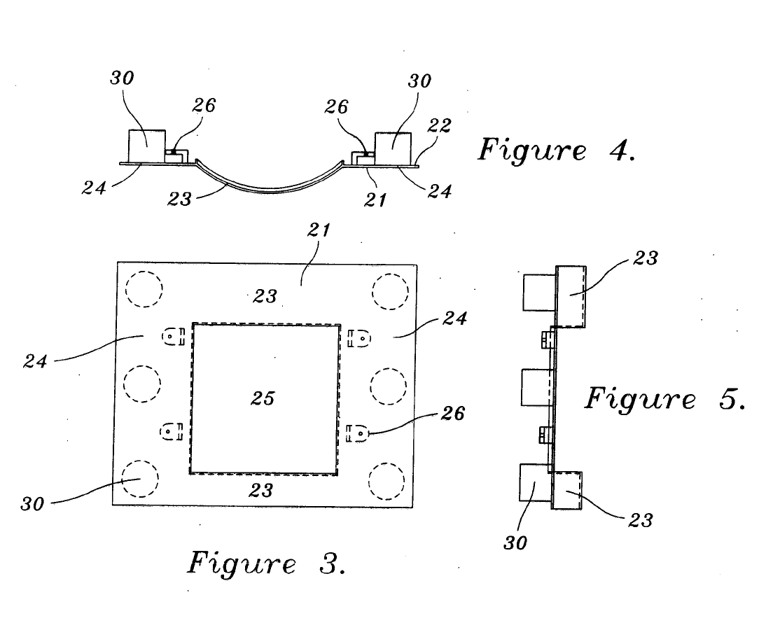

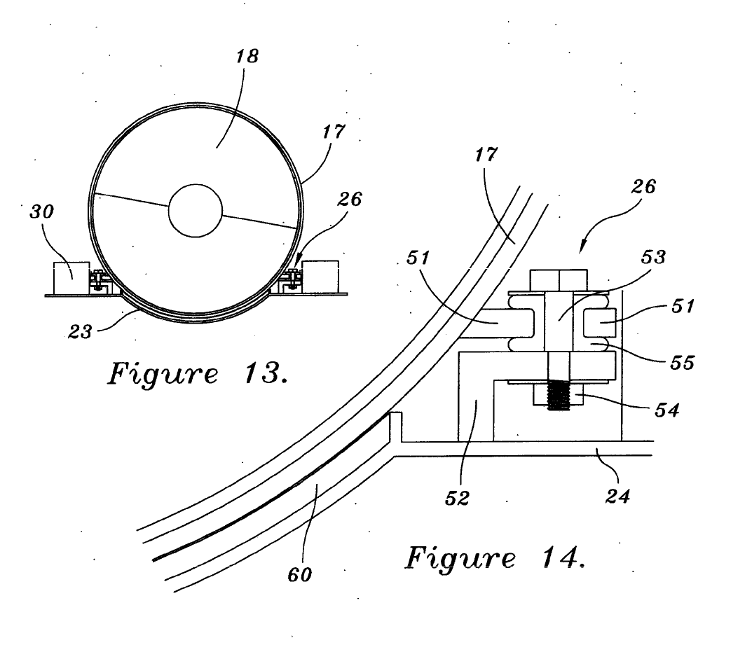

FIGS. 13 and 14 illustrate the placement and detail of the isolating connection assembly (26). Conveyor housing mounting bracket (51) with an appropriately sized aperture is welded to the exterior of the conveyor enclosing tube (17). Shield mounting bracket (52) is welded to the back of shield wing portion (24). Placement and configuration of the shield mounting bracket may also be seen in FIGS. 3 and 4, where it is indicated as part of mounting assembly (26). Connector (53), which is illustrated as a bolt with a nut (54), passes through apertures in housing mounting bracket (51) and shield mounting bracket (52). Isolating grommet (55) prevents acoustical contact between the mounting brackets and between the connector (53) and housing mounting bracket (51). Other options for acoustical isolation will be evident to persons of skill in the art. For example, and isolating pad could be inserted between brackets (51) and (52) and the connector could be fabricated from a non-acoustic-conducting material.

It is also advisable to maintain an air gap between the curved portion the shield (23) and the conveyor enclosing tube (17) to inhibit vibration transfer to the tube and consequent energy loss. A gap of about one-eighth inch (3-4 mm) is appropriate. To prevent ice particles from falling into the air gap, a thin sealing flange (60) is incorporated in the structure of the back surface of shield (20) all the way around aperture (25) corresponding to mouth (19) of the conveyor enclosing tube (17). The flange does not touch the tube, but closes the air gap to a few thousandths of an inch (0.05 mm) at its location.

The invention is suitable as a retrofit modification for existing ice resurfacing machines, as there is space in most common configurations to add the sheild assembly

The foregoing description of a preferred embodiment of the invention has been presented and is intended for the purposes of illustration and description. It is not intended to be exhaustive nor limit the invention to the precise form disclosed and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated. Therefore, it is intended that the invention not be limited to the particular embodiments disclosed for carrying out the invention.

What is claimed is:

1. An ice resurfacing machine having an ultrasonic vibrating shield mounted around an input aperture in a vertical conveyor enclosing tube.

2. The machine of claim 1 including at least one ultrasonic transducer sonically coupled to the shield.

3. The machine of claim 2 wherein the shield is sonically isolated from the enclosing tube.

4. The machine of claim 3 wherein the transducer comprises a piezoelectric element.

5. The machine of claim 4 wherein the transducer further comprises a protective cover and the transducer is electrically coupled to an ultrasonic signal generator.

6. The machine of claim 1 further including a plurality of ultrasonic transducers sonically coupled to the shield.

7. The machine of claim 6 wherein the shield is sonically isolated from the enclosing tube.

8. The machine of claim 7 wherein the transducers comprise piezoelectric elements.

9. The machine of claim 8 wherein each transducer further comprises a protective cover and the transducers are electrically coupled to an ultrasonic signal generator.

10. A method of clearing ice from the area around an intake aperture in a vertical conveyor enclosing tube comprising the steps of attaching a shield closely around the aperture and causing the shield to vibrate with ultrasonic vibrations.

11. The method of claim 10 wherein the shield comprises a blade sonically coupled to at least one piezoelectric transducer driven by an ultrasonic generator.

12. A kit for improving the operation of an ice resurfacing machine comprising a shield adapted to fit closely around an intake aperture of a vertical conveyor enclosing tube in the machine and at least one transducer sonically coupled to the shield.

13. The kit of claim 12 wherein the at least one transducer compromises a piezoelectric transducer element with a protective cover and further comprising an ultrasonic signal generator connected to the transducer and adapted to fit on a main body of the machine.

14. The kit of claim 13 further including a bracket adapted to be welded to the vertical conveyor enclosing tube for mating with a bracket on the shield in a sonically isolated manner.
